(19) United States
(12) Patent Application Publication
(10) Pub. No.: US 2005/0061602 A1
(43) Pub. Date: Mar. 24, 2005

(54) Multiple disc clutch for automatic transmission

(76) Inventor: Jae-Joon Yi, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,234

(22) Filed: Dec. 30, 2003

(30) Foreign Application Priority Data
Sep. 23, 2003 (KR) 10-2003-0065809

(51) Int. Cl. F16D 25/0638

(52) U.S. Cl. 192/85 AA; 188/71.5; 188/72.4

(57) ABSTRACT

A multiple disc clutch for an automatic transmission wherein overlapped clutch plates and a piston applying pressure to clutch discs, and a spring retainer supporting a distal end of a spring resiliently supporting the piston are all made of pressed steel, enabling them to reduce their thicknesses, while satisfying a required rigidity. This shortens the entire length of the multiple disc clutch. The entire length of the automatic transmission applied with a multiple disc clutch structure can be shortened to create more space in an engine room.

### CROSS-REFERENCE TO RELATED APPLICATIONS

This application claims priority to Korean Application No. 10-2003-0065809, filed on Sep. 23, 2003, the disclosure of which is incorporated fully herein by reference.

### FIELD OF THE INVENTION

The present invention relates to a multiple disc clutch for an automatic transmission and, more particularly, to a multiple disc clutch for an automatic transmission of reduced overall length.

### BACKGROUND OF THE INVENTION

In general, a multiple plate clutch comprises a plurality of clutch plates and clutch discs to transmit power by way of friction between the plates and the discs. An under drive clutch, over drive clutch, reverse clutch, and the like are used in an automatic transmission to control the power transmitted from a torque converter. A piston and a spring retainer used for the multiple clutch is generally made in aluminum die casting with a minimum required thickness for satisfying a specified rigidity, resulting in an increase of the entire length of the automatic transmission. When an automatic transmission is manufactured with an increased allowable torque capacity for meeting an engine specification under circumstances where an engine output is gradually increased, the automatic transmission may increase by an entire length. This gives rise to another problem of difficulty in mounting the automatic transmission in an engine room while maintaining an existing design specification. There is still another problem in that D-rings installed at a piston and a spring retainer are separately manufactured and assembled apart from the piston and the spring retainer, thus lengthening the assembly process in an assembly line for automatic transmissions.

### SUMMARY OF THE INVENTION

The present invention is a multiple disc clutch for an automatic transmission configured so that the thickness of a piston and a spring retainer is reduced, thus shortening the overall length of an automatic transmission. Further, an existing D-ring assembly process is eliminated, thus shortening the assembly process in an automatic transmission assembly line. The present invention, a multiple disc clutch for an automatic transmission, comprises a plurality of clutch plates movably and longitudinally mounted in a retainer. Clutch discs, each positioned between the clutch plates, are mounted on a hub. A piston slidably moving in the retainer and a position-fixed spring retainer are disposed between the retainer and the hub. And a spring for resiliently supporting the piston is installed with the spring retainer, wherein the piston and the spring retainer are circumferentially and respectively formed with lip seals.

### BRIEF DESCRIPTION OF THE DRAWING

For a better understanding of the nature and objects of the present invention, reference should be made to the following detailed description with the accompanying drawings, in which:

FIG. 1 is a cross-sectional view of a multiple disc clutch for an automatic transmission according to an embodiment of the present invention.

### DETAILED DESCRIPTION OF THE PREFERRED EMBODIMENT

The preferred embodiment of the present invention will now be described in detail with reference to the annexed drawings.

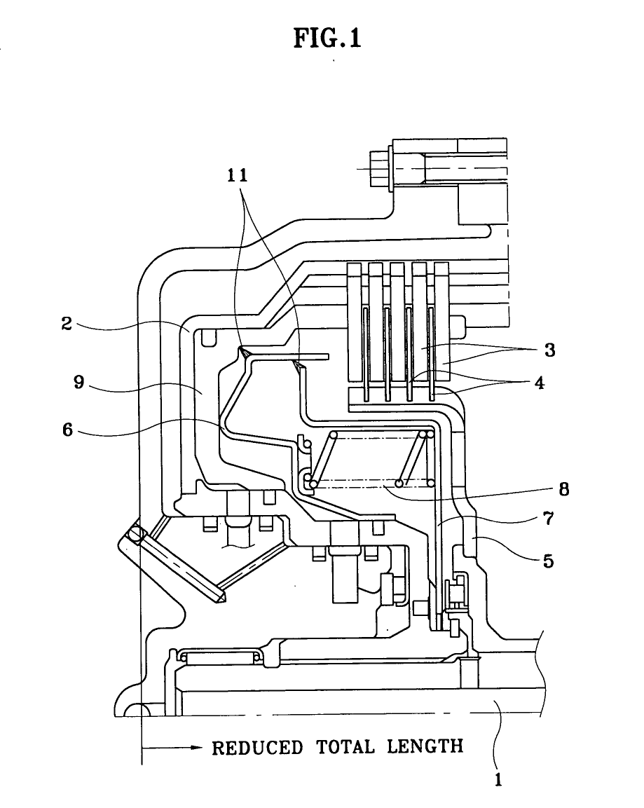

As shown in FIG. 1, a multiple disc clutch for an automatic transmission according to an embodiment of the present invention has a piston 6 and a spring retainer 7, each made with a reduced thickness. The mechanical structure of the present invention is the same as that of the prior art.

A plurality of clutch plates 3 are movably and longitudinally splined to a retainer 2 integrally rotating with an input axle 1 to which power from an engine is transmitted. Clutch discs 4, each positioned between the clutch plates 3, are mounted on a hub 5. A piston 6, slidably moving in the retainer 2, and a spring retainer 7, position-fixed in the retainer 2 in the axial direction, are disposed between the retainer 2 and the hub 5. A spring 8 for resiliently supporting the piston 6 is attached to the spring retainer 7. The piston 6 and the spring retainer 7 made of pressed steel are manufactured, not by die casting like the prior art, but by press processing. As a result, the piston 6 and the spring retainer 7 are respectively reduced in thickness, compared with those formed by the conventional aluminum die-cast method, while being able to meet a required rigidity.

Each part of the multiple disc clutch for an automatic transmission is shortened in length, thus shortening the entire length of the automatic transmission. Consequently, even if an automatic transmission, increased in allowable torque capacity in relation to high-output engine development, is to be manufactured, an increase of an entire length of the transmission can be avoided, thereby enabling the transmission to be mounted in an engine room without modification.

The piston 6 and the spring retainer 7 are circumferentially and respectively formed with lip seals 11, where each lip seal 11 is bonded before the piston 6 and the spring retainer 7 are attached to an automatic transmission assembly line. As a result, D-rings need not be inserted into grooves circumferentially formed at a piston and a spring retainer in an automatic transmission assembly line in contrast to the conventional method. In other words, a conventional process of assembling D-rings in an automatic transmission line can be eliminated, thus shortening the assembly process.

As apparent from the foregoing, there is an advantage in the multiple disc clutch for an automatic transmission thus described according to the embodiment of the present invention in that a multiple clutched piston and spring retainer are made of pressed steel such that even a single part of reduced thickness can meet a required rigidity, enabling the entire length of the automatic transmission to be shortened. There is another advantage in that even if there is a need to increase required torque capacity allowance, the entire length of an automatic transmission does not need to be increased. Therefore, there are no difficulties in accommodating the transmission in an engine room. A final advantage in that bonded lip seals are delivered such that D-rings are not assembled in an automatic transmission assembly line, thereby shortening the assembly process.

1. A multiple disc clutch for an automatic transmission, wherein:
a plurality of clutch plates movably and longitudinally are mounted in a retainer;
clutch discs, each positioned between said clutch plates, are mounted on a hub;
a piston slidably moving in said retainer and a position-fixed spring retainer are disposed between said retainer and said hub; and
a spring for resiliently supporting said piston is installed with said spring retainer, wherein said piston and said spring retainer are circumferentially and respectively formed with lip seals.

2. The multiple disc clutch for an automatic transmission as defined in claim 1, wherein said piston and said spring retainer are made of pressed steel.
